(19) United States
(12) Patent Application Publication
(10) Pub. No.: US 2018/0074367 A1
(43) Pub. Date: Mar. 15, 2018

(54) LIQUID CRYSTAL DEVICE AND ELECTRONIC APPARATUS

(71) Applicant: SEIKO EPSON CORPORATION, Tokyo (JP)

(72) Inventors: Daisuke MIYAWAKI, Chitose-shi (JP); Jun SATO, Matsumoto-shi (JP)

(73) Assignee: SEIKO EPSON CORPORATION, Tokyo (JP)

(21) Appl. No.: 15/695,110

(22) Filed: Sep. 5, 2017

(30) Foreign Application Priority Data
Sep. 13, 2016 (JP) 2016-178286

(51) Int. Cl. G02F 1/1335; G02F 1/1341; G02F 1/1339; G02F 1/1333; G02F 1/1343; G09G 3/36

(52) U.S. Cl. CPC G02F 1/133512; G02F 1/1341; G09G 3/3648; G02F 1/133351; G02F 1/134336; G02F 1/1339

(57) ABSTRACT

In a liquid crystal device, liquid crystal molecules are oriented between a first substrate provided with pixel electrodes and a second substrate provided with a common electrode in a quadrangular display area. In a casing area between a seal material and a display area in the second substrate, a light blocking area, in which a first shading layer is formed along a side of the display area, and a light transmission area, which has higher light transmittance than the light blocking area, are provided. In the first substrate, a second shading layer, which overlaps light transmission area in plan view, is provided.

### BACKGROUND

### 1. Technical Field

The present invention relates to a liquid crystal device, in which a liquid crystal layer is maintained between a pair of substrates, and an electronic apparatus.

### 2. Related Art

A liquid crystal device includes a first substrate which is provided with a plurality of pixel electrodes and a first oriented film, a second substrate which is provided with a common electrode and a second oriented film, and a seal material which bonds the first substrate to the second substrate. A liquid crystal layer is maintained in an area surrounded by the seal material between the first substrate and the second substrate. In the liquid crystal device, an image is displayed by causing light source light to be incident from a side of the second substrate and changing posture of liquid crystal molecules by the pixel electrodes. Here, due to the change in the posture of the liquid crystal molecules, fluidization is generated in the liquid crystal layer. As a result, impurities, which are mixed when the liquid crystal layer is charged, or impurities, which are eluted from the seal material, are activated due to light irradiation, and are aggregated in corners or the like of the display area, thereby generating deterioration, such as burning (stain) of an image, of display qualities. Here, there is proposed a method of preventing the burning or the like of the image by aggregating impurities in a location which is separated from the display area.

However, in the second substrate, the shading layer is formed to surround the display area. Therefore, in an area which overlaps the shading layer in plan view, the liquid crystal layer is not irradiated with light. Therefore, impurities are congested without being activated, and thus the impurities are aggregated in a boundary between the display area and the shading layer. Here, there is proposed a configuration in which parts, which are located on outer sides of corners of the display area, of the shading layer are cut off and are set to light transmission area, and the impurities are moved up to a location which is separated from the display area (refer to JP-A-2013-228425).

In a case where cut-offs (light transmission area) are provided in the shading layer and light from a light source is transmitted through the light transmission area of the shading layer as in the configuration disclosed in JP-A-2013-228425, light, which is transmitted through the light transmission area, leaks after being transmitted through the first substrate, and thus there is a problem in that display qualities are deteriorated.

### SUMMARY

An advantage of some aspects of the invention is to provide a liquid crystal device and an electronic apparatus which are capable of preventing aggregation of impurities at an edge of a display area by providing a light transmission area in a casing area which surrounds the display area and preventing leakage of light, thereby improving display qualities.

There is provided a liquid crystal device including: a first substrate that includes a plurality of pixel electrodes and a first oriented film; a second substrate that includes a common electrode and a second oriented film; a seal material that bonds the first substrate to the second substrate; and a liquid crystal layer that is maintained in an area surrounded by the seal material between the first substrate and the second substrate, in which, in a frame-shaped casing area interposed between the seal material and a quadrangular display area, the second substrate is provided with a light blocking area, in which a first shading layer is provided along sides of the display area, and a light transmission area which has higher light transmittance than the light blocking area, and, in which the first substrate is provided with a second shading layer which overlaps the light transmission area in plan view.

According to an aspect of the invention, an image is displayed in such a way that light source light is incident from a side of the second substrate and posture of liquid crystal molecules is changed by the pixel electrodes. Here, impurities, which are mixed when the liquid crystal layer is charged, or impurities, which are eluted from the seal material, move toward a side on which the liquid crystal molecules are oriented in the display area, and are aggregated. Here, since the casing area is provided with the light blocking area provided with the first shading layer along the side of the display area and the light transmission area which has higher light transmittance than the light blocking area, the liquid crystal layer is irradiated with light, which is incident from the side of the second substrate, in the light transmission area. Accordingly, in a state in which the impurities are activated, the impurities move to a location separated from the display area in the area which overlaps the casing area, and are aggregated in the location. Therefore, it is difficult that deterioration in the display qualities, such as burning (stain) of an image, is generated due to the aggregated impurities. In addition, since the first substrate is provided with the second shading layer which overlaps the light transmission area of the second substrate, it is possible to prevent light, which is transmitted through the light transmission area, from being transmitted through the first substrate or the like and leaking. Accordingly, it is difficult that deterioration in the display qualities due to leakage of light which is transmitted through the light transmission area.

According to the aspect of the invention, the light transmission area may correspond to openings of the first shading layer.

According to the aspect of the invention, the light transmission area may be a partial transmission film which causes light to be partially transmitted.

According to the aspect of the invention, the first oriented film or the second oriented film may cause liquid crystal molecules of the liquid crystal layer to be oriented from one side of a set, in which a facing-distance is long, toward one side of a set, in which the facing-distance is short, among two sets of sides, which face each other, of the display area, and to be oriented from another side of the set, in which the facing-distance is short, toward another side of the set in which the facing-distance is long.

According to the aspect of the invention, a direction, in which the liquid crystal molecules of the liquid crystal layer are oriented, may have an angle of 45° or 135° with respect to one side of the set in which the facing-distance is long.

According to the aspect of the invention, the light transmission area may be provided on an outer side of four corners of the display area. The impurities are easily concentrated on two corners of the corners of the display area. Therefore, in a case where the light transmission area is provided on the outer side of the corners, the impurities move to the location separated from the display area at the two corners, and are aggregated in the location. Therefore, it is difficult that deterioration in the display qualities, such as burning (stain) of the image, is generated due to the aggregated impurities. In addition, in a case where the light transmission area is provided on the outer side of the four corners, it is possible to apply the invention to a case where setting is performed along a diagonal line in which orientation directions are different in accordance with the specification of the liquid crystal device.

According to the aspect of the invention, the light transmission area may be provided over an entire periphery of the display area.

According to the aspect of the invention, the light transmission area may extend along two sides of a set, in which a facing-distance is long, among two sets of sides, which face each other, of the display area.

According to the aspect of the invention, the first substrate may include a dummy pixel electrode in the light blocking area along a side of the display area, and the light transmission area may be formed to correspond to the dummy pixel electrode.

In addition, according to another aspect of the invention, there is provided a liquid crystal device including: a first substrate that includes a plurality of pixel electrodes and a first oriented film; a second substrate that includes a common electrode and a second oriented film; a seal material that bonds the first substrate to the second substrate; and a liquid crystal layer that is maintained in an area surrounded by the seal material between the first substrate and the second substrate, in which the second substrate is provided with a first shading layer, which includes a partial transmission film that causes light to be partially transmitted, over an entire periphery of the frame-shaped casing area which is interposed between the seal material and the quadrangular display area, and in which the first substrate is provided with a second shading layer which overlaps the first shading layer in plan view.

According to the aspect of the invention, an image is displayed in such a way that light source light is incident from a side of the second substrate and posture of liquid crystal molecules is changed by the pixel electrodes. Here, impurities, which are mixed when the liquid crystal layer is charged, or impurities, which are eluted from the seal material, move toward a side on which the liquid crystal molecules are oriented in the display area, and are aggregated. Here, the casing area is provided with the first shading layer which includes the partial transmission film that causes light to be partially transmitted over an entire periphery of the casing area. Therefore, in the casing area, the liquid crystal layer is irradiated with light which is incident from the side of the second substrate. Accordingly, in a state in which the impurities are activated, the impurities move to the location separated from the display area in an area which overlaps the casing area, and are aggregated in the location. Therefore, it is difficult that deterioration in the display qualities, such as burning (stain) of the image, is generated due to the aggregated impurities. In addition, since the first substrate is provided with the second shading layer which overlaps the light transmission area of the second substrate in plan view, it is possible to prevent light, which is transmitted through the light transmission area, from being transmitted through the first substrate or the like and leaking. Accordingly, it is difficult that deterioration in the display qualities due to leakage of light which is transmitted through the light transmission area.

According to the aspect of the invention, the second shading layer may include the same layer as wirings or the electrodes which are provided in the display area of the first substrate. According to the aspect, it is not necessary to add a film-forming process and a patterning process in order to provide the second shading layer.

According to the aspect of the invention, the second shading layer may include a reflective metal layer. According to the aspect, it is possible to prevent light, which is transmitted through the light transmission area, from being absorbed by the second shading layer and generating heat.

According to the aspect of the invention, the first oriented film and the second oriented film may have a columnar structure, and the liquid crystal molecules of the liquid crystal layer may have negative dielectric anisotropy.

It is possible to use the liquid crystal device to which the invention is applied for various electronic apparatuses such as a direct viewing-type display apparatus and a projection-type display apparatus. In a case where the electronic apparatus is a projection-type display apparatus, the projection-type display apparatus may further include a light source section that emits light to be supplied to the liquid crystal device; and a projection optical system that projects light which is modulated by the liquid crystal device, in which, in the liquid crystal device, light which is emitted from the light source section is supplied from a side of the second substrate.

### BRIEF DESCRIPTION OF THE DRAWINGS

The invention will be described with reference to the accompanying drawings, wherein like numbers reference like elements.

FIG. 1 is a block diagram illustrating an electrical configuration of a liquid crystal device according to Embodiment 1 of the invention.

FIG. 2 is a plan view of the liquid crystal device according to Embodiment 1 of the invention.

FIG. 3 is a sectional view of the liquid crystal device taken along a line III-III illustrated in FIG. 2.

FIG. 4 is a plan view of a pixel of the liquid crystal device illustrated in FIG. 2.

FIG. 5 is a sectional view of a pixel taken along a line V-V illustrated in FIG. 4.

FIG. 6 is an explanatory view of a casing area illustrated in FIG. 2.

FIG. 7 is a sectional view of the liquid crystal device taken along a line VII-VII illustrated in FIG. 2.

FIG. 8 is a sectional view of the liquid crystal device taken along a line VIII-VIII illustrated in FIG. 2.

FIG. 9 is a plan view of a liquid crystal device according to Embodiment 2 of the invention.

FIG. 10 is an explanatory view of a casing area illustrated in FIG. 9.

FIG. 11 is a sectional view of the liquid crystal device taken along a line XI-XI illustrated in FIG. 9.

FIG. 12 is a plan view of a liquid crystal device according to Embodiment 3 of the invention.

FIG. 13 is a plan view of a liquid crystal device according to Embodiment 4 of the invention.

FIG. 14 is a sectional view of the liquid crystal device taken along a line XIV-XIV illustrated in FIG. 13.

FIG. 15 is a schematic configuration diagram of a projection-type display apparatus (electronic apparatus) using the liquid crystal device to which the invention is applied.

### DESCRIPTION OF EXEMPLARY EMBODIMENTS

Embodiments of the invention will be described with reference to the accompanying drawings. Meanwhile, in the drawings which are referred to below, each layer and each member are shown in sizes which can be recognized on the drawing, and thus the scales thereof are different for each layer and each member. Meanwhile, when a layer which is formed on a first substrate is described, an upper layer side or a surface side means a side (side on which a second substrate is located) opposite to a side on which the substrate main body of the first substrate is located, and a lower layer side means a side (side opposite to a side on which the second substrate is located) on which the substrate main body of the first substrate is located.

### Embodiment 1

### Electrical Configuration of Display Area

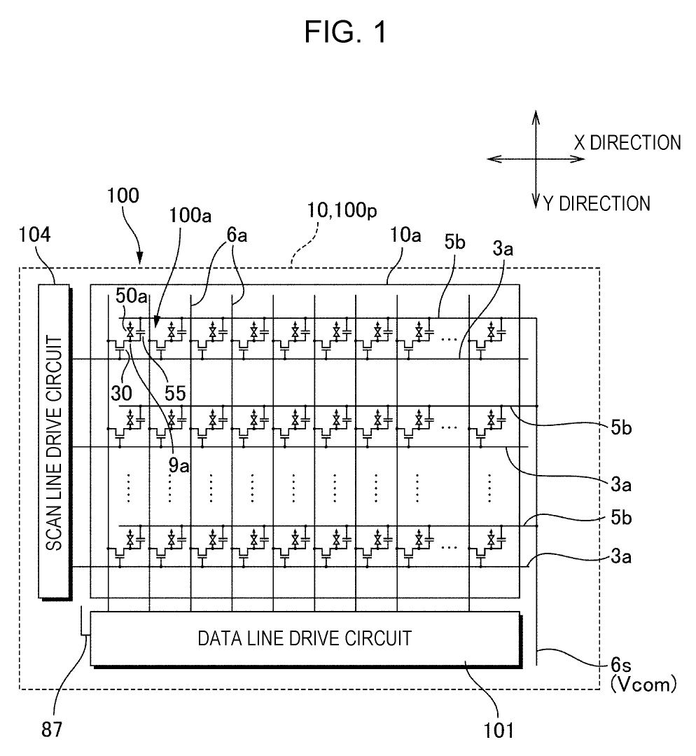

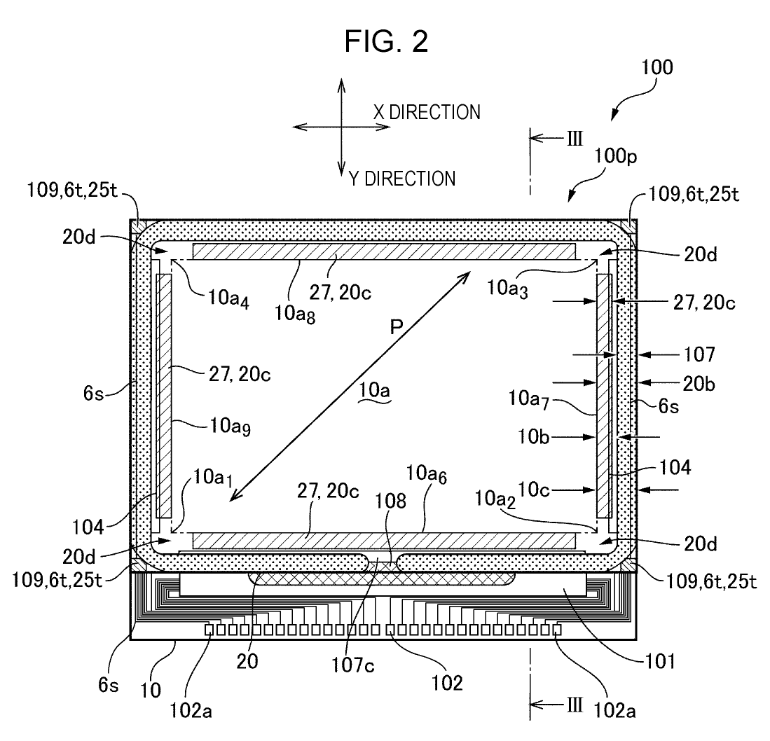

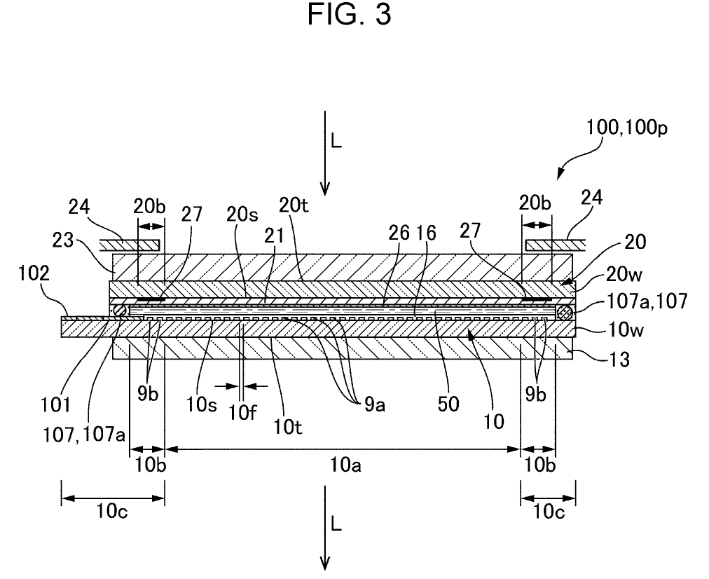

FIG. 1 is a block diagram illustrating an electrical configuration of a liquid crystal device according to Embodiment 1 of the invention. Meanwhile, FIG. 1 is a block diagram illustrating only the electrical configuration, and does not illustrate directions in which wires or electrodes are formed or extend, a layout, or the like. In FIG. 1, a liquid crystal device 100 includes a liquid crystal panel 100p in a Vertical Alignment (VA) mode, and the liquid crystal panel 100p includes a display area 10a (pixel arrangement area/available pixel area) in which a plurality of pixels 100a are arranged in a matrix shape at a central area of the display area 10a. In the liquid crystal panel 100p, a plurality of data lines 6a (image signal lines) and a plurality of scan lines 3a extend in vertical and horizontal directions on a first substrate 10 (element substrate: refer to FIGS. 2 and 3), which will be described later, inside the display area 10a, and the pixels 100a are formed in the locations corresponding to intersections of the lines. In each of the plurality of pixels 100a, a pixel transistor 30, which includes a field effect-type transistor, and a pixel electrode 9a, which will be described later, are formed. The data line 6a is electrically connected to a source of the pixel transistor 30, the scan line 3a is electrically connected to a gate of the pixel transistor 30, and the pixel electrode 9a is electrically connected to a drain of the pixel transistor 30.

In the first substrate 10, a scan line drive circuit 104 and a data line drive circuit 101 are provided on outer sides of the display area 10a. The data line drive circuit 101 is electrically connected to each of the data lines 6a, and sequentially supplies an image signal, which is supplied from the image processing circuit, to each of the data lines 6a. The scan line drive circuit 104 is electrically connected to each of the scan lines 3a, and sequentially supplies a scan signal to each of the scan lines 3a.

In each pixel 100a, the pixel electrode 9a faces a common electrode formed on a second substrate (counter substrate: refer to FIGS. 2 and 3 or the like), which will be described later, through a liquid crystal layer, and forms a liquid crystal capacity 50a. A storage capacity 55 is added to each pixel 100a in parallel to the liquid crystal capacity 50a in order to prevent variation in an image signal which is maintained in the liquid crystal capacity 50a. In the embodiment, in order to form the storage capacity 55, a capacity line 5b, which extends over the plurality of pixels 100a, is provided on the first substrate 10. In the embodiment, the capacity line 5b is electrically conducted to a constant potential wiring 6s to which common potential Vcom is applied.

### Configurations of Liquid Crystal Panel and First Substrate

FIG. 2 is a plan view of the liquid crystal device 100 according to Embodiment 1 of the invention, and illustrates an aspect in which the liquid crystal device 100 is viewed from a side of a second substrate 20 together with each component. FIG. 3 is a sectional view taken along a line III-III of the liquid crystal device 100 illustrated in FIG. 2.

As illustrated in FIGS. 2 and 3, in the liquid crystal device 100, the light-transmitting first substrate 10 and the light-transmitting second substrate 20 are bonded by a seal material 107 through a predetermined gap, and the seal material 107 is provided in a rectangular frame shape along an outer edge of the second substrate 20. The seal material 107 is an adhesive, which is formed of a photocurable resin or a thermosetting resin, and a gap material 107a, such as glass fibers or glass beads, is combined in order to set a distance between both the substrates to a predetermined value. In the liquid crystal panel 100p, a liquid crystal layer 50 is maintained in an area, which is surrounded by the seal material 107, between the first substrate 10 and the second substrate 20. In the seal material 107, a cutting-off part 107c which is used as a liquid crystal inlet is formed, and the cutting-off part 107c is occupied by an encapsulation material 108 after a liquid crystal material is injected. Meanwhile, after the seal material 107 is formed in an endless frame shape with respect to the first substrate 10, the liquid crystal layer 50 may be provided on an inner side of the seal material 107. Thereafter, the second substrate 20 may be bonded to the first substrate 10 by the seal material 107.

In the embodiment, both the first substrate 10 and second substrate 20 have quadrangular shapes, and the display area 10a, which is described with reference to FIG. 1, is provided approximately at a center of the liquid crystal panel 100p as a quadrangular area. The seal material 107 is also provided approximately in a quadrangular shape so as to correspond to the shapes of the substrates, and a quadrangular frame-shaped outer peripheral area 10c is provided on an outer side of the display area 10a.

In the first substrate 10, the data line drive circuit 101 and a plurality of terminals 102 are formed along one side of the first substrate 10 in the outer peripheral area 10c, and the scan line drive circuit 104 is formed along another side which is adjacent to the one side. A flexible wiring substrate (not shown in the drawing) is connected to the terminals 102, and various potentials and various signals are input to the first substrate 10 through the flexible wiring substrate.

Although details will be described later, on a side of one side surface 10s, which faces the second substrate 20, in the one side surface 10s and another side surface 10t of the first substrate 10, the pixel transistors 30, which are described with reference to FIG. 1, and the pixel electrodes 9a, which are electrically connected to the pixel transistors 30, are formed in a matrix shape in the display area 10a on the side of the one side surface 10s of the display area 10a, and an oriented film 16 (first oriented film) is formed on an upper layer side of the pixel electrodes 9a.

In addition, in a quadrangular frame-shaped area 10b, which is interposed between the display area 10a and the seal material 107, of the outer peripheral area 10c on an outer side than the display area 10a, dummy pixel electrodes 9b, which are formed simultaneously with the pixel electrodes 9a, are formed. With regard to the dummy pixel electrodes 9b, for example, adjacent dummy pixel electrodes 9b are connected by a coupling section which has a narrow width. The common potential Vcom is applied to the dummy pixel electrodes 9b, and the dummy pixel electrodes 9b prevent disorder of orientation of liquid crystal molecules at ends on an outer peripheral side of the display area 10a. Meanwhile, there is a case where potential is not applied to the dummy pixel electrodes 9b and thus the dummy pixel electrodes 9b are in a potentially floating state.

A common electrode 21 is formed on the side of the one side surface 20s, which faces the first substrate 10, in the one side surface 20s and another side surface 20t of the second substrate 20, and an oriented film 26 (second oriented film) is laminated on a surface of the common electrode 21. The common electrode 21 is formed over approximately entire surface of the second substrate 20 or the plurality of pixels 100a as a plurality of strip electrodes. In the embodiment, the common electrode 21 is formed on an approximately entire surface of the second substrate 20.

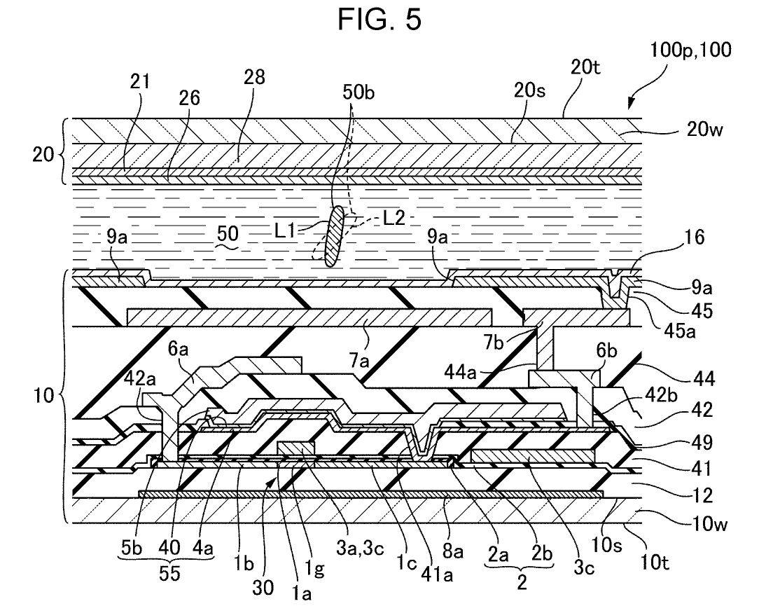

In the second substrate 20, a first shading layer 27 is formed on a lower layer side of the common electrode 21 in a frame-shaped casing area 20b interposed between the seal material 107 and the display area 10a. In the embodiment, as will be described later, a light blocking area 20c, in which the first shading layer 27 is formed, and a light transmission area 20d, which has higher light transmittance than the light blocking area 20c, are formed in the casing area 20b. A light-transmitting protective layer 28 (see FIG. 5), which includes a silicon oxide film, is formed between the first shading layer 27 and the common electrode 21. In addition, a black matrix part, which overlaps inter-pixel areas 10f interposed between the adjacent pixel electrodes 9a in plan view on the lower layer side of the common electrode 21, may be formed on a side of the one side surface 20s of the second substrate 20. In this case, the black matrix part is formed by the same shading layer as the first shading layer 27.

In the liquid crystal panel 100p, on an outer side than the seal material 107, electrode parts 25t for conduction between substrates are formed at four corners on the side of the one side surface 20s of the second substrate 20, and electrode parts 6t for conduction between substrates are formed in locations which face the four corners (electrode parts 25t for conduction between substrates) of the second substrate 20 on the side of the one side surface 10s of the first substrate 10. In the embodiment, the electrode parts 25t for conduction between substrates include a part of the common electrode 21. The electrode parts 6t for conduction between substrates are electrically conducted to the constant potential wiring 6s to which the common potential Vcom is applied, and the constant potential wiring 6s is electrically conducted to common potential application terminals 102a of the terminals 102. An inter-substrate conduction material 109, which includes conductive particles, is disposed between the electrode parts 6t for conduction between substrates and the electrode parts 25t for conduction between substrates, and the common electrode 21 of the second substrate 20 are electrically connected to the side of the first substrate 10 through the electrode parts 6t for conduction between substrates, the inter-substrate conduction material 109, and the electrode parts 25t for conduction between substrates. Therefore, the common potential Vcom is applied to the common electrode 21 from the side of the first substrate 10. The seal material 107 is provided along an outer periphery of the second substrate 20 with approximately the same width dimension. Accordingly, seal material 107 has an approximately quadrangular shape. However, the seal material 107 is provided to pass through an inner side while avoiding the electrode parts 6t and 25t for conduction between substrates in areas which are superimpose the corners of the second substrate 20.

In the liquid crystal device 100 according to the configuration, in the embodiment, the pixel electrode 9a and the common electrode 21 are formed of a light transmitting conductive film, such as Indium Tin Oxide (ITO) or Indium Zinc Oxide (IZO), and the liquid crystal device 100 is a transmission-type liquid crystal device. In the transmission-type liquid crystal device 100, as illustrated using arrow L in FIG. 3, an image is displayed in such a way that light, which is incident from a side of the second substrate 20, is modulated during a time when light is transmitted through the first substrate 10 and is emitted. Meanwhile, there is a case where the common electrode 21 is formed of the light transmitting conductive film, and the pixel electrode 9a is formed of a reflective conductive film such as aluminum film. According to the configuration, it is possible to form a reflection-type liquid crystal device 100. In the reflection-type liquid crystal device 100, an image is displayed in such a way that light, which is incident from the side of the second substrate 20, is modulated during a time when light is reflected in the first substrate 10 and is emitted from the second substrate 20 again.

It is possible to use the liquid crystal device 100 as a color display apparatus of an electronic apparatus, such as a mobile computer or a mobile phone. In this case, a color filter (not shown in the drawing) is formed on the second substrate 20 or the first substrate 10. In addition, in the liquid crystal device 100, a polarizing film, a phase-difference film, a polarizing plate, and the like are disposed with respect to the liquid crystal panel 100p in a predetermined direction according to a type, an orientation direction, or normal white mode/normal black mode of the liquid crystal layer 50 to be used. Furthermore, it is possible to use the liquid crystal device 100 as RGB light valves in a projection-type display apparatus (liquid crystal projector) which will be described later. In this case, respective color lights, which are separated through RGB color separation dichroic mirrors, are incident into the respective RGB liquid crystal devices 100 as projection lights, and thus color filters are not formed.

In the embodiment, the liquid crystal device 100 is a transmission-type liquid crystal device that is used as the RGB light valves in the projection-type display apparatus which will be described later. Therefore, as illustrated in FIG. 3, a light-transmitting first dustproof glass 13 is pasted to another side surface 10t, which is on a side opposite to the liquid crystal layer 50, of the first substrate 10, by an adhesive agent or the like, and a light-transmitting second dustproof glass 23 is pasted to another side surface 20t, which is on a side opposite to the liquid crystal layer 50, of the second substrate 20 by the adhesive agent or the like. In addition, in the liquid crystal panel 100p, a light-shading parting edge 24 is disposed on the second substrate 20 on a side (light incident side) opposite to the first substrate 10. An inner edge of the parting edge 24 overlaps the first shading layer 27, which is formed on the second substrate 20, in plan view, and is positioned on an outer side than the inner edge of the casing area 20b (first shading layer 27). The parting edge 24 includes, for example, an end plate part of a frame (not shown in the drawing) which maintains the liquid crystal panel 100p on an inside thereof or a plate-shaped member which is fixed to the frame. In addition, there is a case where the parting edge 24 is formed by the shading layer which is formed in the second dustproof glass 23.

### Detailed Configuration of Pixel

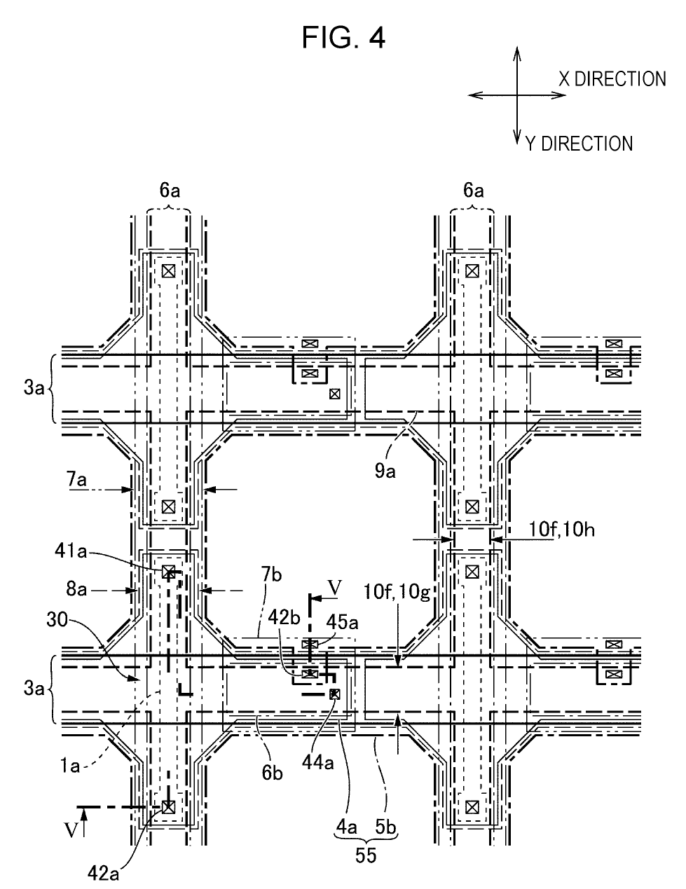

FIG. 4 is a plan view of a pixel of the liquid crystal device 100 illustrated in FIG. 2. FIG. 5 is a sectional view of the pixel illustrated in FIG. 4 taken along a line V-V. Meanwhile, in FIG. 4, respective layers are illustrated using the following lines. In addition, in FIG. 4, locations of ends of layers, in which the ends overlap each other, are deviated such that shapes or the like of the layers are easily understood.

Thin and long broken line indicates a shading layer 8a on the lower layer side.

Thin and short dotted line indicates a semiconductor layer 1a.

Thick solid line indicates the scan line 3a.

Thin solid line indicates a drain electrode 4a.

Thin chain line indicates the data line 6a and a relay electrode 6b.

Thick chain line indicates the capacity line 5b.

Thin two-dot chain line indicates a shading layer 7a and a relay electrode 7b on the upper layer side.

Thick broken line indicates the pixel electrode 9a.

As illustrated in FIG. 4, the pixel electrode 9a is formed for each of the plurality of pixels 100a on the one side surface 10s of the first substrate 10. In the embodiment, the pixel electrode 9a has a planar shape of an approximately square, and the data line 6a and the scan line 3a are formed along an inter-pixel area 10f, which extends in the vertical direction (Y direction) and horizontal direction (X direction), between adjacent pixel electrodes 9a in the first substrate 10. More specifically, the scan line 3a extends in straight along a first inter-pixel area 10g, which extends in an X direction (first direction), of the inter-pixel area 10f, and the data line 6a extends in straight along a second inter-pixel area 10h which extends in the Y direction (second direction). In addition, the pixel transistor 30 is formed to correspond to an intersection of the data line 6a and the scan line 3a, and the pixel transistor 30 is formed using the intersection of the data line 6a and the scan line 3a and a vicinity of the intersection.

The capacity line 5b is formed on the first substrate 10, and the common potential Vcom is applied to the capacity line 5b. In the embodiment, the capacity line 5b extends to overlap the scan line 3a and the data line 6a and is formed in a lattice shape. The shading layer 7a is formed on the upper layer side of the pixel transistor 30, and the shading layer 7a extends to overlap the data line 6a. The shading layer 8a is formed on the lower layer side of the pixel transistor 30, and the shading layer 8a includes a main line part which linearly extends to overlap the scan lines 3a, and a sub-line part which extends to overlap the data line 6a at the intersection between the data line 6a and the scan line 3a.

As illustrated in FIG. 5, in the first substrate 10, the lower layer-side shading layer 8a, which includes a conductive film, such as a conductive polysilicon film, a metal silicide film, a metal film or a metal compound film, is formed on the substrate surface (on the side of the one side surface 10s which faces the second substrate 20) on a side of the liquid crystal layer 50 of the light transmitting substrate main body 10w, such as a quartz substrate or a glass substrate. In the embodiment, the shading layer 8a includes a shading layer, such as a tungsten silicide (WSi), and, in a case where light which is transmitted through the liquid crystal device 100 is reflected in another member, prevents a malfunction due to photoelectric current from occurring in the pixel transistor 30 because the reflected light is incident into the semiconductor layer 1a. There is a case where the shading layer 8a is formed as the scan line, and, in this case, a gate electrode 3c, which will be described later, is formed to be conducted to the shading layer 8a.

On a side of the one side surface 10s of the substrate main body 10w, a light-transmitting insulation film 12, such as a silicon oxide film, is formed on the upper layer side of the shading layer 8a, and the pixel transistor 30, which includes the semiconductor layer 1a, is formed on a surface side of the insulation film 12. The pixel transistor 30 includes a semiconductor layer 1a which faces a longitudinal direction in an extension direction of the data line 6a, and a gate electrode 3c which extends in a direction which is perpendicular to a length direction of the semiconductor layer 1a and overlaps a central part of the semiconductor layer 1a in the length direction. In the embodiment, the gate electrode 3c includes a part of the scan line 3a. The pixel transistor 30 includes a light-transmitting gate insulation layer 2 between the semiconductor layer 1a and the gate electrode 3c. The semiconductor layer 1a includes a channel area 1g which faces the gate electrode 3c through the gate insulation layer 2, and a source area 1b and a drain area 1c on both sides of the channel area 1g. The pixel transistor 30 has an LDD structure. Accordingly, the source area 1b and the drain area 1c each include low-density areas on both sides of the channel area 1g and include a high-density area in an area which is adjacent to the low-density areas on a side opposite to the channel area 1g.

The semiconductor layer 1a is formed by a polysilicon film (polycrystalline silicon film) or the like. The gate insulation layer 2 is formed of, for example, a two-layered structure which includes a first gate insulation layer 2a that includes a silicon oxide film acquired by performing thermal oxidation on the semiconductor layer 1a, and a second gate insulation layer 2b that is formed of a silicon oxide film formed using a low pressure CVD method or the like. The gate electrode 3c and the scan line 3a include a conductive film, such as a conductive polysilicon film, a metal silicide film, a metal film, or a metal compound film.

A light-transmitting inter-layer insulation film 41, which includes a silicon oxide film, is formed on an upper layer side of the gate electrode 3c, and the drain electrode 4a is formed on an upper layer of the inter-layer insulation film 41. The drain electrode 4a includes a conductive film such as a conductive polysilicon film, a metal silicide film, a metal film, or a metal compound film. The drain electrode 4a is formed to have a part which overlaps a drain area 1c (pixel electrode-side source drain area) of the semiconductor layer 1a, and is electrically conducted to the drain area 1c through a contact hole 41a which is transmitted through the inter-layer insulation film 41 and the gate insulation layer 2.

A light-transmitting insulation film 49, which includes a silicon oxide film or the like, and the light-transmitting dielectric layer 40 are formed on an upper layer side of the drain electrode 4a, and the capacity line 5b is formed on an upper layer side of the dielectric layer 40. It is possible to use a silicon compound, such as a silicon oxide film and a silicon nitride film, as the dielectric layer 40. In addition, it is possible to use a high dielectric constant dielectric layer such as an aluminum oxide film, a titanium oxide film, a tantalum oxide film, a niobium oxide film, a hafnium oxide film, a lantern oxide film, or a zirconium oxide film. The capacity line 5b includes a conductive film such as a conductive polysilicon film, a metal silicide film, a metal film, or a metal compound film. The capacity line 5b overlaps the drain electrode 4a through the dielectric layer 40, and forms the storage capacity 55.

A light-transmitting inter-layer insulation film 42, which includes a silicon oxide film, is formed on an upper layer side of the capacity line 5b, and the data line 6a and the relay electrode 6b are formed of the same conductive film on an upper layer side of the inter-layer insulation film 42. The data line 6a and relay electrode 6b include a conductive film such as a conductive polysilicon film, a metal silicide film, a metal film, or a metal compound film. The data line 6a is electrically conducted to the source area 1b (data line-side source drain area) through a contact hole 42a which is transmitted through the inter-layer insulation film 42, the insulation film 49, the inter-layer insulation film 41, and the gate insulation layer 2. The relay electrode 6b is electrically conducted to the drain electrode 4a through a contact hole 42b which is transmitted through the inter-layer insulation film 42 and the insulation film 49.

A light-transmitting inter-layer insulation film 44, which includes a silicon oxide film, is formed on an upper layer side of the data line 6a and the relay electrode 6b, and the shading layer 7a and the relay electrode 7b are formed of the same conductive film on an upper layer side of the inter-layer insulation film 44. A surface of the inter-layer insulation film 44 is flattened. The shading layer 7a and the relay electrode 7b include a conductive film such as a conductive polysilicon film, a metal silicide film, a metal film, or a metal compound film. The relay electrode 7b is electrically conducted to the relay electrode 6b through a contact hole 44a which is transmitted through the inter-layer insulation film 44. The shading layer 7a extends to overlap the data line 6a, and functions as the shading layer. Meanwhile, the shading layer 7a may be electrically conducted to the capacity line 5b and may be used as a shield layer. In addition, the capacity line may be formed by the shading layer 7a.

A light-transmitting inter-layer insulation film 45, which includes a silicon oxide film or the like, is formed on an upper layer side of the shading layer 7a and the relay electrode 7b, and the pixel electrode 9a, which includes a light transmitting conductive film such as an ITO film, is formed on an upper layer side of the inter-layer insulation film 45. In the embodiment, the pixel electrode 9a includes an ITO film. A surface of the inter-layer insulation film 45 is flattened.

The pixel electrode 9a partially overlaps the relay electrode 7b, and is electrically conducted to the relay electrode 7b through a contact hole 45a which is transmitted through the inter-layer insulation film 45. As a result, the pixel electrode 9a is electrically connected to the drain area 1c through the relay electrode 7b, the relay electrode 6b, and the drain electrode 4a. The oriented film 16 (first oriented film), which includes an inorganic oriented film, a polyimide film, or the like, is formed on a surface of the pixel electrode 9a. In the embodiment, the oriented film 16 is a columnar structure (tilted vertical oriented film/inorganic oriented film) which includes an oblique vapor deposition film such as SiOₓ (x<2), SiO₂, TiO₂, MgO, Al₂O₃, In₂O₃, Sb₂O₃, or Ta₂O₅.

In the second substrate 20, the protective layer 28, which includes a silicon oxide film or the like, and the common electrode 21, which includes a light transmitting conductive film such as an ITO film, are formed on a surface (one side surface 20s which faces the first substrate 10) of a light-transmitting substrate main body 20w (light transmitting substrate), such as a quartz substrate or a glass substrate, on the side of the liquid crystal layer 50, and an oriented film 26 (second oriented film), which includes an inorganic oriented film, a polyimide film, or the like, is formed to cover the common electrode 21. In the embodiment, the common electrode 21 includes an ITO film. The oriented film 26 is a columnar structure (tilted vertical oriented film/inorganic oriented film) which includes an oblique vapor deposition film such as SiOₓ (x<2), SiO₂, TiO₂, MgO, Al₂O₃, In₂O₃, Sb₂O₃, or Ta₂O₅, similarly to the oriented film 16. The oriented films 16 and 26 have antiparallel orientation restricting force, and cause nematic liquid crystal compounds having negative dielectric anisotropy used for the liquid crystal layer 50 to be tilted and vertically orientated such that the liquid crystal compounds are tilted in a fixed direction (pre-tilt direction) from a normal line direction with respect to the first substrate 10 and a normal line direction with respect to the second substrate 20 as liquid crystal molecules 50b are schematically illustrated using solid line L1 as illustrated in FIG. 5. Furthermore, the liquid crystal molecules 50b are tilted due to electric fields between the pixel electrodes 9a and the common electrode 21 as illustrated by dotted line L2. In this manner, the liquid crystal panel 100p is formed as a liquid crystal panel in a normal black VA mode.

As an example, the first oriented film 16 or the second oriented film 26 are formed to cause the liquid crystal molecules 50b of the liquid crystal layer 50 to be oriented from one side 10a₇ (first side) of a set, in which the facing-distance is long, toward one side 10a₆ (second side) of a set, in which the facing-distance is short, among two sets of sides, which face each other, of the display area 10a, and to cause the liquid crystal molecules 50b of the liquid crystal layer 50 to be oriented from another side 10a₈ (third side) of the set, in which the facing-distance is short, toward another side 10a₉ (fourth side) of the set, in which the facing-distance is long. In the embodiment, when viewed from the side of the first substrate 10, there is an area in which the liquid crystal molecules 50b are oriented from the side 10a₈ (third side) toward the side 10a₆ (second side) as illustrated by arrow P of FIG. 2, and the pre-tilt direction of the liquid crystal molecules 50b is set to 45° or 135° with respect to the side 10a₇ (first side) or the side 10a₉ (fourth side) of the set, in which the facing-distance is long, of the display area 10a. In addition, the orientation direction of the liquid crystal molecules 50b is set to a direction toward a corner 10a₃ from a corner 10a₁ and a direction toward the corner 10a₁ from the corner 10a₃ in the four corners 10a₁ to 10a₄ of the quadrangular display area 10a. That is, the liquid crystal molecules 50b are oriented in a direction along a diagonal line which connects the two corners 10a₁ and 10a₃ in the four corners 10a₁ to 10a₄ of the quadrangular display area 10a. Meanwhile, in the liquid crystal molecules 50b, the liquid crystal molecules 50b which are located to be close to a surface of the first substrate 10 are in a state in which one side end of a molecule chain is maintained on the side of the first substrate 10, and the liquid crystal molecules 50b which are located to be close to a surface of the second substrate 20 are in a state in which another side end of the molecule chain is maintained on the side of the second substrate 20.

Although not illustrated in the drawings, in the data line drive circuit 101 and the scan line drive circuit 104, which are described with reference to FIGS. 1 and 2, a complementary transistor circuit or the like, which includes an n-channel drive transistor and a p-channel drive transistor, is formed. Here, the drive transistor is formed using a part of a process of manufacturing the pixel transistor 30. Therefore, the area, in which the data line drive circuit 101 and the scan line drive circuit 104 are formed, of the first substrate 10 has an approximately similar configuration as a sectional configuration illustrated in FIG. 5.

### Detailed Configuration of Casing Area

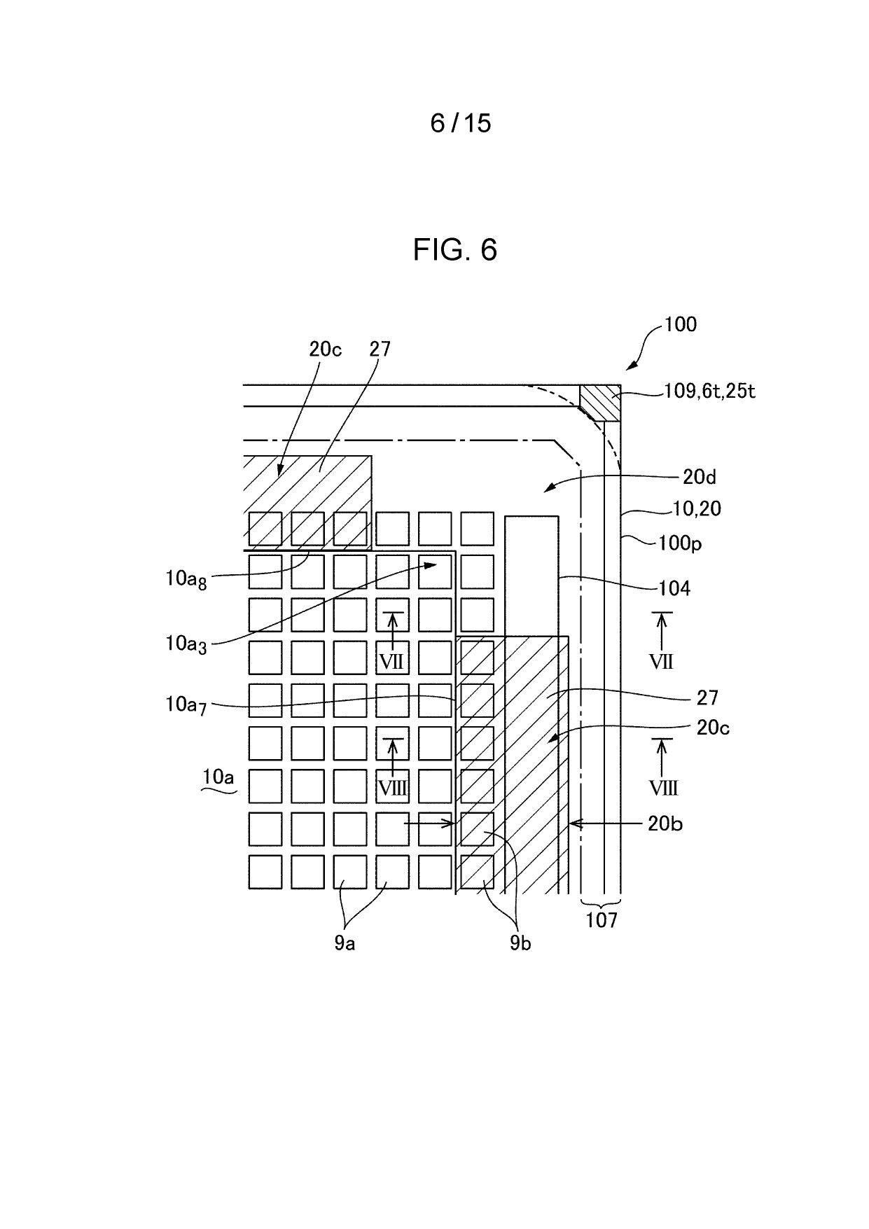

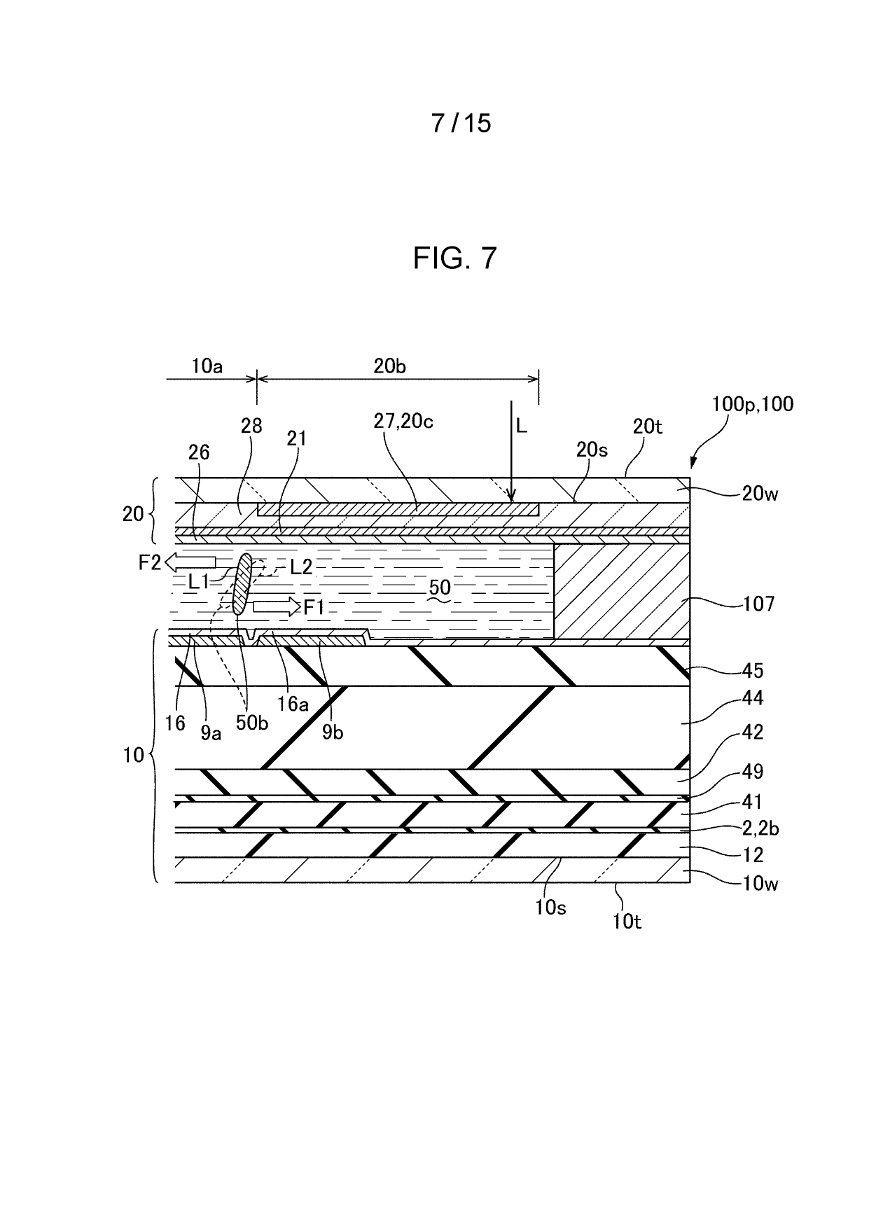

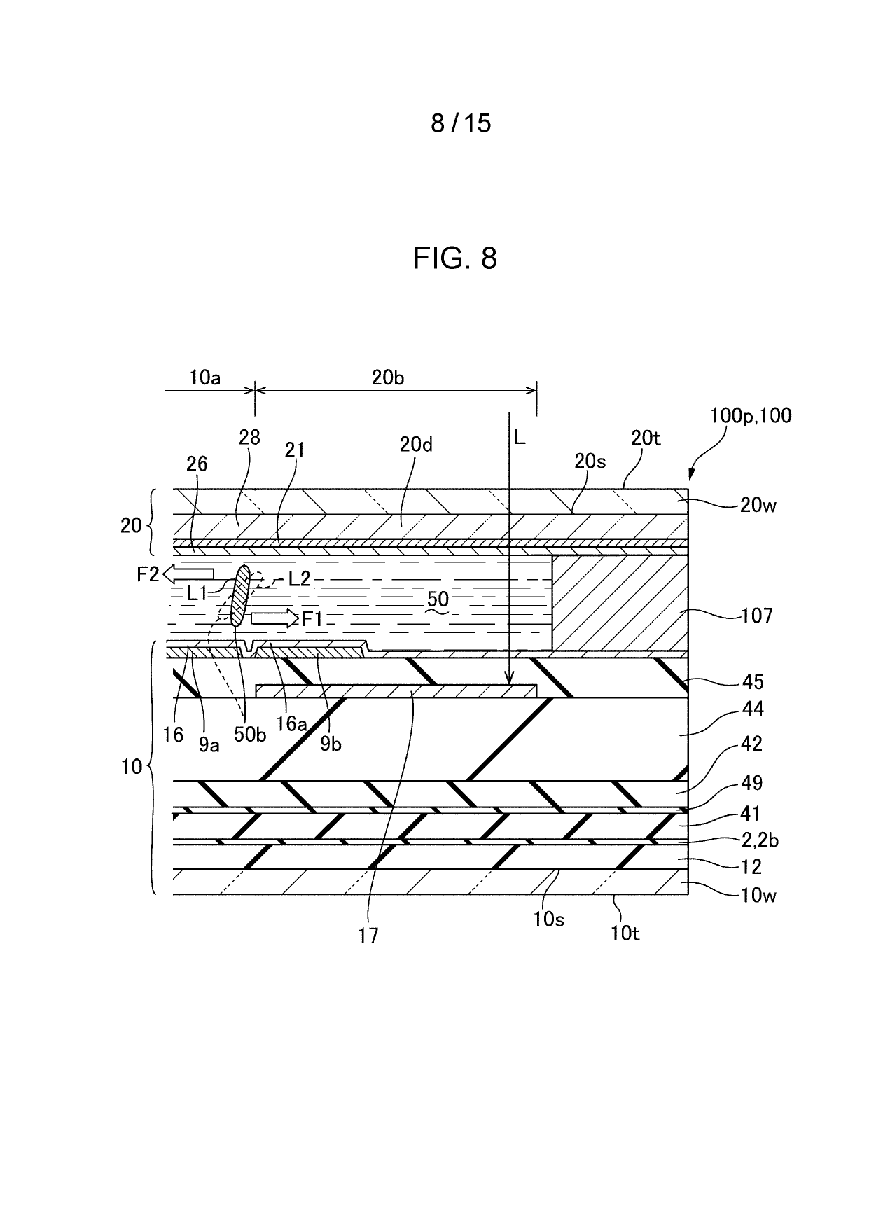

FIG. 6 is an explanatory view of the casing area 20b illustrated in FIG. 2, and is an explanatory view enlarging and illustrating a vicinity of the corner 10a₃ of the display area 10a. FIG. 7 is a sectional view of the liquid crystal device taken along a line VII-VII illustrated in FIG. 2. FIG. 8 is a sectional view of the liquid crystal device 100 taken along a line VIII-VIII illustrated in FIG. 2.

As illustrated in FIGS. 2, 3 and 6, in the second substrate 20, the light blocking area 20c, in which the first shading layer 27 is formed on the lower layer side of the common electrode 21, is provided in the casing area 20b which surrounds the display area 10a on the inner side of the seal material 107. In addition, in the casing area 20b which surrounds the display area 10a, the light transmission area 20d, which has higher light transmittance than the light blocking area 20c, is provided on an outer side of two corners 10a₁ and 10a₃ of the display area 10a, which is located in an orientation direction of the liquid crystal molecules 50b. In the embodiment, the light transmission area 20d is provided on an outer side of the four corners 10a₁ to 10a₄ of the display area 10a. Accordingly, although the first shading layer 27 (light blocking area 20c) is formed along four sides 10a₆, 10a₇, 10a₈, and 10a₉ of the display area 10a, the first shading layer 27 is cut off and includes openings on the outer side of the four corners 10a₁ to 10a₄.

As illustrated in FIGS. 6 and 7, the first shading layer 27 overlaps the dummy pixel electrodes 9b in plan view, and an inner edge of the first shading layer 27 overlaps an edge of the display area 10a in plan view. An outer edge of the first shading layer 27 is located to be separated from an inner periphery of the seal material 107 with a gap. Accordingly, the first shading layer 27 does not overlap the seal material 107 in plan view.

As illustrated in FIGS. 6 and 8, the light transmission area 20d is an area in which the first shading layer 27 is not formed. In addition, in the first substrate 10, a second shading layer 17, which overlaps the light transmission area 20d in plan view, is formed. In the embodiment, the second shading layer 17 is a shading layer which includes the same layer as the electrodes and the wirings which are formed in the display area 10a of the first substrate 10. In the embodiment, the second shading layer 17 includes the same layer as the shading layer 7a and the relay electrode 7b illustrated in FIG. 5. In the embodiment, the shading layer 7, the relay electrode 7b and the second shading layer 17 include a reflective metal layer such as an aluminum alloy or a multi-layer film including an aluminum film.

In the liquid crystal device which is formed as described above, light, which is incident into the light blocking area 20c, in light, which is incident into the casing area 20b from the side of the second substrate 20, is blocked by the first shading layer 27 of the light blocking area 20c, and thus light is not incident into the liquid crystal layer 50 which overlaps the light blocking area 20c in plan view (see FIG. 7). In contrast, light, which is incident into the light transmission area 20d, is incident into the liquid crystal layer 50 which overlaps the light blocking area 20c in plan view, and, thereafter, is blocked by the second shading layer 17.

Meanwhile, in the embodiment, although the light transmission area 20d is formed using the area in which the first shading layer 27 is not formed, the light transmission area 20d may be formed using a partial transmission film which has higher light transmittance than the first shading layer 27. The partial transmission film includes a semi-transmission film, which is acquired by forming the light-shading film to be thin, or a dielectric multilayer.

### Main Advantage of Embodiment

As described above, in the liquid crystal device 100 according to the embodiment, an image is displayed in such a way that light source light is incident from the side of the second substrate 20 and the posture of the liquid crystal molecules 50b is changed by the pixel electrodes 9a. Here, with the change in the posture of the liquid crystal molecules 50b, impurities, which are mixed when the liquid crystal layer 50 is charged, or impurities, which are eluted from the seal material 107, move toward a side on which the liquid crystal molecules 50b are oriented in the display area 10a, and are aggregated. Here, it is assumed that a spot where impurities are most concentrated is a part having a long distance in a direction (direction in which the impurities move) in which the liquid crystal molecules 50b are oriented in the display area 10a. In the embodiment, the spot where the impurities are most concentrated corresponds to the vicinity of the two corners 10a₁ and 10a₃ which are located in the side (side indicated by arrow P) on which the liquid crystal molecules 50b are oriented. In response to the embodiment, in the embodiment, the outer side of the two corners 10a₁ and 10a₃ becomes the light transmission area 20d. Therefore, the liquid crystal layer 50 is irradiated with light, which is incident from the side of the second substrate 20, on the outer side (light transmission area 20d) of the two corners 10a₁ and 10a₃. Therefore, in a state in which the impurities are activated without being congested, the impurities move to a location which is separated from the display area 10a, and are aggregated in the location. Therefore, it is difficult that deterioration in the display qualities, such as burning (stain) of an image, is generated due to the aggregated impurities.

In addition, in the first substrate 10, the second shading layer 17, which overlaps the light transmission area 20d of the second substrate 20 in plan view, is provided. Therefore, it is possible to prevent light, which is transmitted through the light transmission area 20d, from being transmitted through the first substrate 10 and leaking. Accordingly, it is difficult that a state of deterioration in the display qualities due to the leakage of the light, which is transmitted through the light transmission area 20d, is generated.

In addition, since the second shading layer 17 includes the same layer as the wirings or the electrodes which are provided in the display area 10a of the first substrate 10, it is not necessary to add a film-forming process and a patterning process in order to provide the second shading layer 17. In addition, since the second shading layer 17 includes the reflective metal layer, it is possible to prevent light, which is transmitted through the light transmission area 20d, from being absorbed by the second shading layer 17 and generating heat.

In addition, in the embodiment, the light transmission area 20d is provided on the entire outer side of the four corners 10a₁ to 10a₄. Therefore, according to the specifications of the liquid crystal device 100, even in a case where the orientation direction of the liquid crystal molecules 50b is set to a direction which is orthogonal with respect to arrow P, it is possible to aggregate the impurities in a location which is separated from the display area 10a.

In addition, in the embodiment, the light blocking area 20c extends to be long along sides 10a₆ to 10a₉ except the outer sides of the corners 10a₁ to 10a₄ of the display area 10a. In addition, in the first substrate 10, the second shading layer 17, which overlaps the light transmission area 20d of the second substrate 20 in plan view, is provided. Therefore, it is possible to properly prevent display light emission area using the light blocking area 20c (first shading layer 27) and the second shading layer 17.

### Embodiment 2

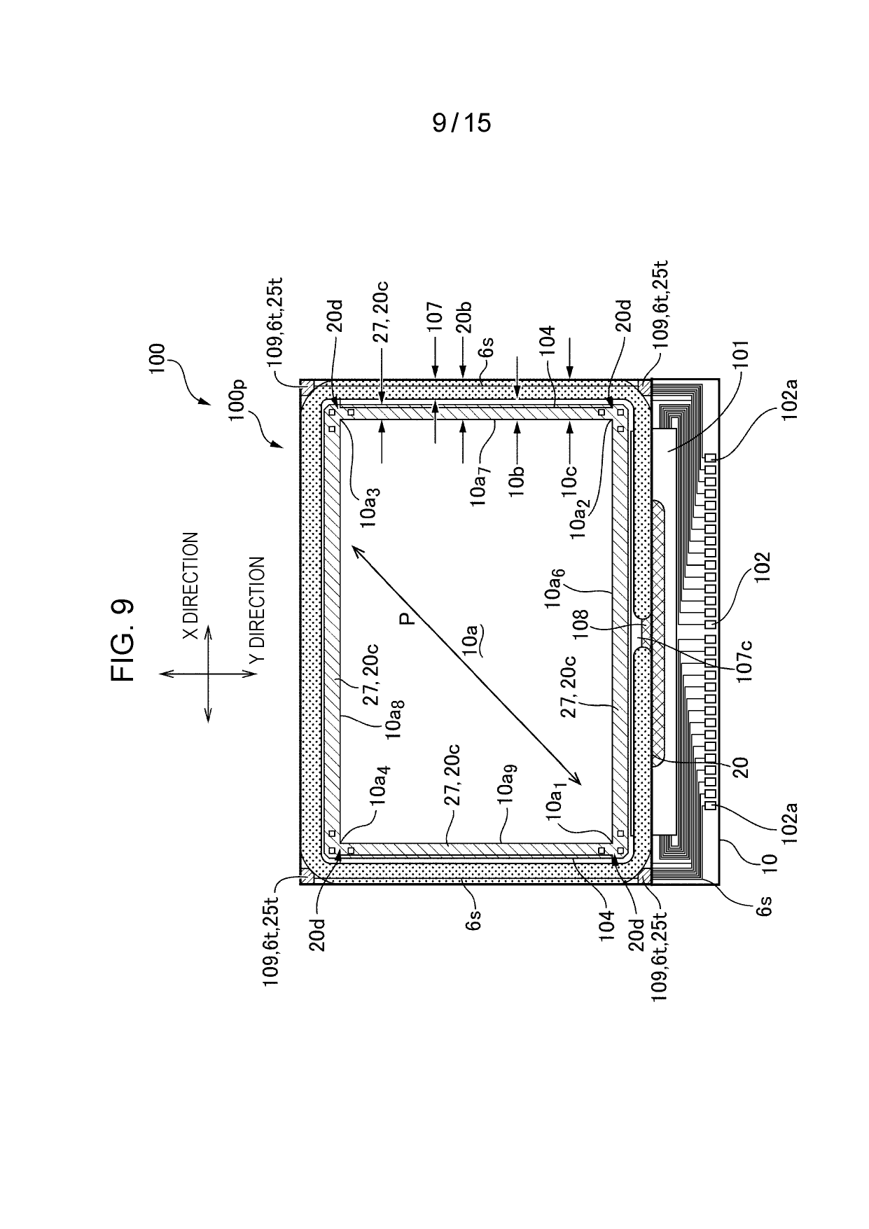

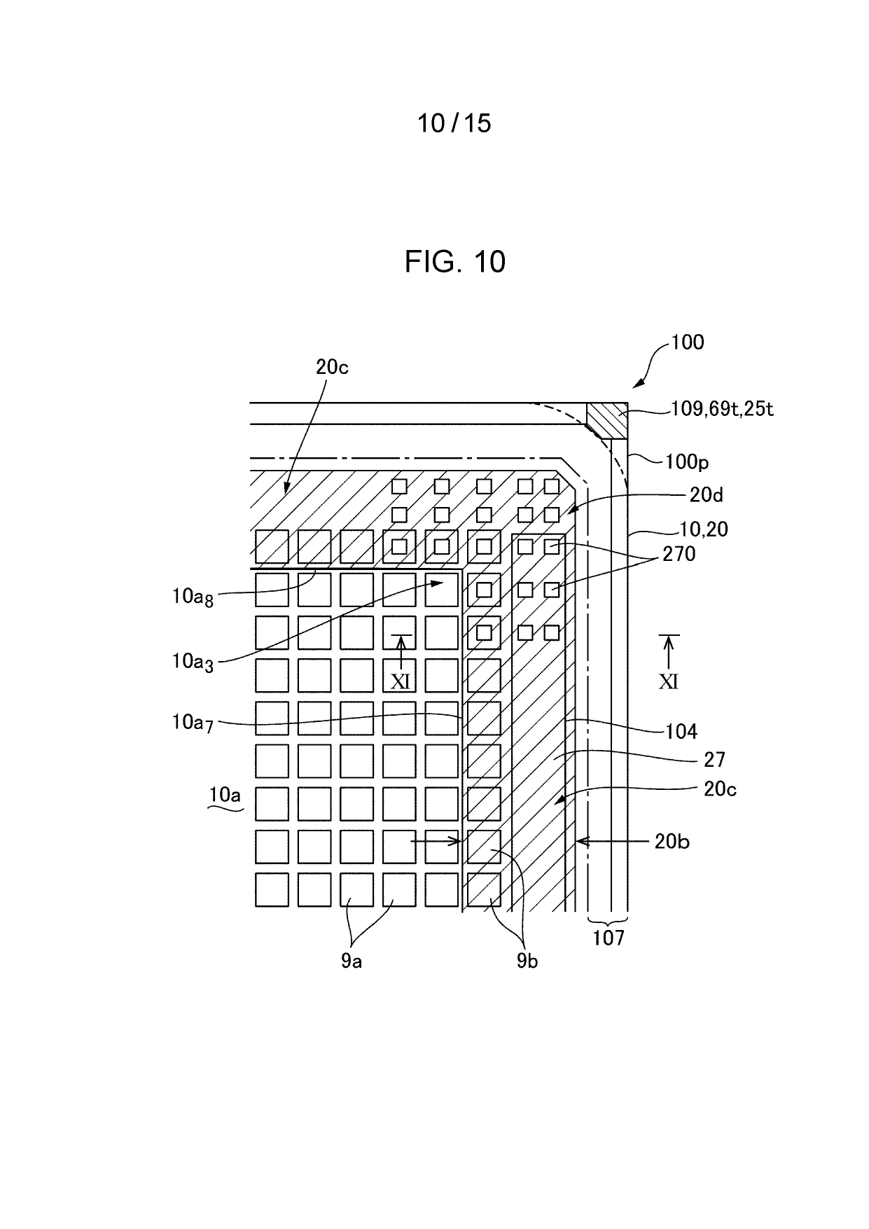

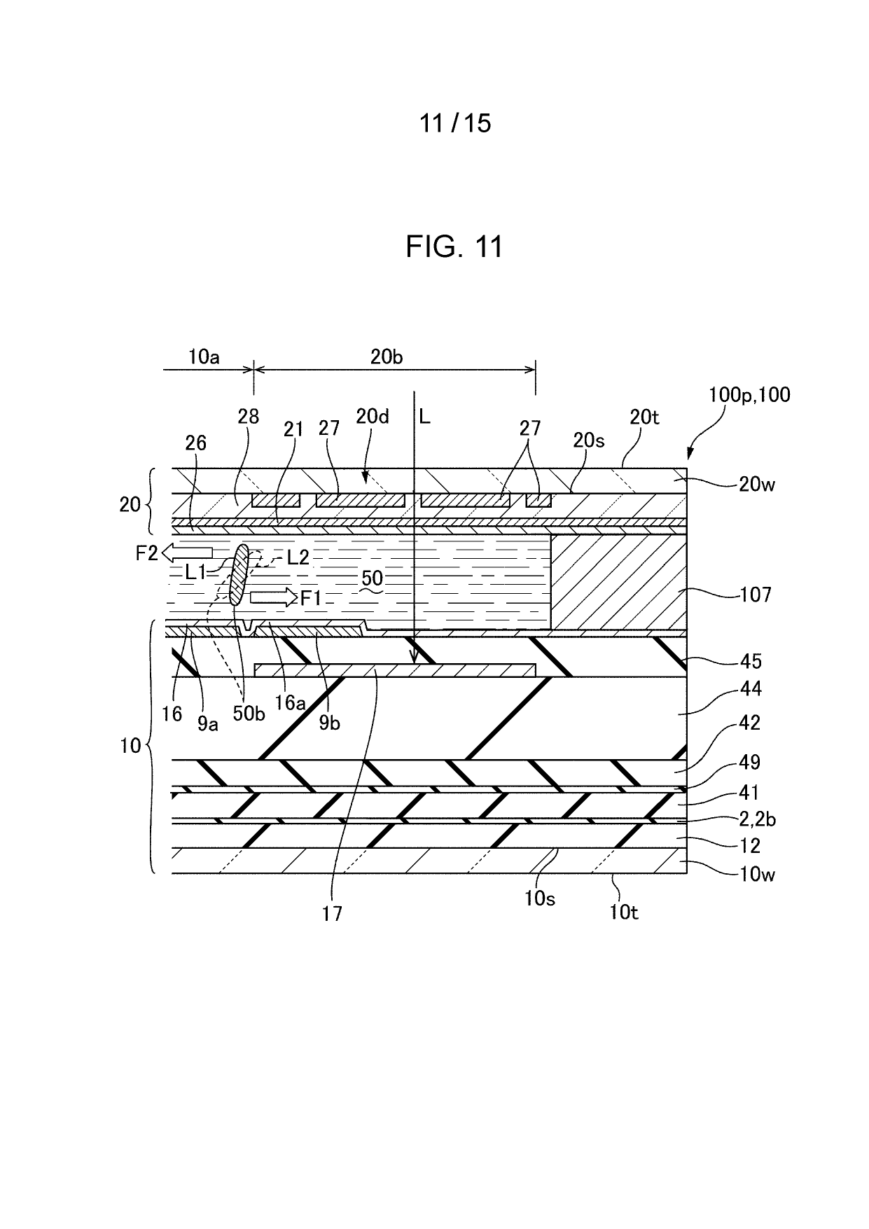

FIG. 9 is a plan view of a liquid crystal panel 100p of the liquid crystal device 100 according to Embodiment 2 of the invention. FIG. 10 is an explanatory view of the casing area 20b illustrated in FIG. 9, and is an explanatory view enlarging and illustrating the vicinity of the corner 10a₃ of the display area 10a. FIG. 11 is a sectional view of the liquid crystal device 100 taken along a line XI-XI illustrated in FIG. 9. Meanwhile, since basic configurations of Embodiments 2, 3, and 4, which will be described below, are the same as that of Embodiment 1, common parts will be illustrated with the same reference symbols, and the description thereof will not be repeated.

In Embodiment 1, the light transmission area 20d is an area in which the first shading layer 27 is not formed. However, in the embodiment, as illustrated in FIGS. 9, 10 and 11, the light transmission area 20d is an area in which the first shading layer 27 is partially formed.

Specifically, although the first shading layer 27 is also formed in the light transmission area 20d, a plurality of openings 270 are formed in the first shading layer 27 which is formed in the light transmission area 20d. In the embodiment, the opening 270 is a small part (hole) where the first shading layer 27 is removed and has one side a length of which is ¼ or ½ of the pixel electrode 9a. A part corresponding to approximately ⅕ to ½ of the first shading layer 27, which is formed in the light transmission area 20d, includes the openings 270. In addition, in the embodiment, the openings 270 are formed to correspond to the dummy pixel electrodes 9b. That is, the openings 270 overlap the dummy pixel electrodes 9b in plan view, and one opening 270 is formed with respect to one dummy pixel electrode 9b. Although the opening 270 may overlap between the dummy pixel electrodes 9b, there is a possibility that effect varies.

In addition, in the embodiment, the second shading layer 17, which overlaps the light transmission area 20d in plan view, is formed in the first substrate 10 similarly to Embodiment 1. The second shading layer 17 includes the same layer as the shading layer (the shading layer 7a and the relay electrode 7b) which is formed in the display area 10a of the first substrate 10, and has light flexibility.

In addition, in the embodiment, although the light transmission area 20d is configured with the area in which the first shading layer 27 is partially formed, the light transmission area 20d may be configured with a partial transmission film which has higher light transmittance than the first shading layer 27. The partial transmission film includes a semi-transmission film or a dielectric multi-layered film in which the light-shading film is formed thinly.

Similarly to Embodiment 1, even in the liquid crystal device 100 which is configured as described above, light, which is incident into the light blocking area 20c, of light, which is incident into the casing area 20b from the side of the second substrate 20, is blocked by the first shading layer 27 of the light blocking area 20c, light is not incident into the liquid crystal layer 50 which overlaps the light blocking area 20c in plan view. In contrast, light, which is incident into the light transmission area 20d, is incident into the liquid crystal layer 50 which overlaps the light blocking area 20c in plan view. Accordingly, impurities move to a location, which is separated from the display area 10a in a state in which the impurities are activated, and are aggregated in the location. Therefore, it is difficult that deterioration in the display qualities, such as burning (stain) of an image, is generated due to the aggregated impurities. In addition, since the second shading layer 17, which overlaps the light transmission area 20d of the second substrate 20 in plan view, is provided in the first substrate 10, the same effect as in Embodiment 1 is acquired, that is, it is possible to prevent light, which is transmitted through the light transmission area 20, from being transmitted through the first substrate 10 and then leaking.

Meanwhile, in the embodiment, the openings 270 (light transmission area 20d) are provided only at the corners of the casing area 20b. However, the openings 270 (light transmission area 20d) may be provided over an entire periphery of the casing area 20b.

### Embodiment 3

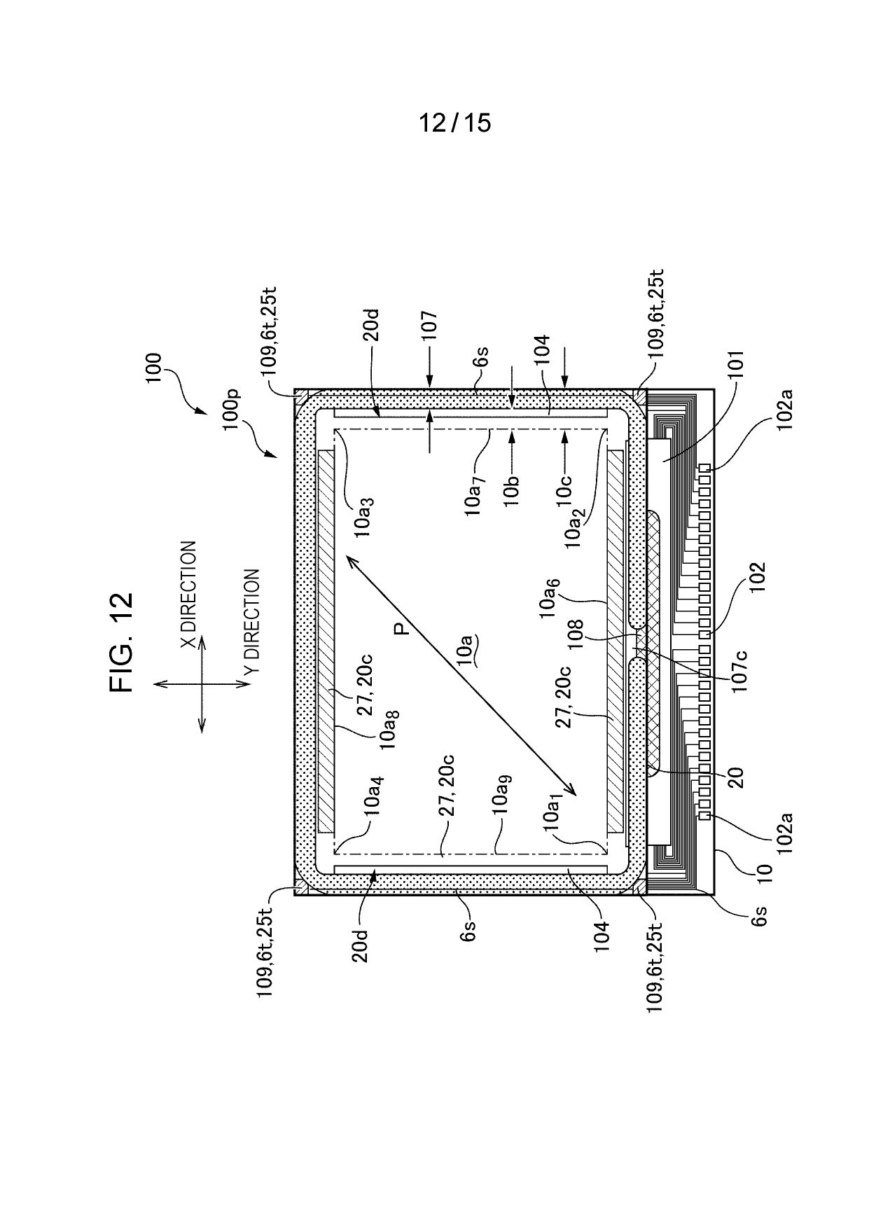

FIG. 12 is a plan view of a liquid crystal device 100 according to Embodiment 3 of the invention. In embodiments 1 and 2, only the outer sides of the corners 10a₁ to 10a₄ of the display area 10a in the casing area 20b become the light transmission area 20d. However, in the embodiment, in addition to the outer sides of the corners 10a₁ to 10a₄ of the display area 10a, outer sides of the sides 10a₇ and 10a₉, which face each other in edges of the display area 10a, become the light transmission area 20d, as illustrated in FIG. 12. Therefore, only outer sides of the sides 10a₆ and 10a₉, which face each other in the edge of the display area 10a, become the light blocking area 20c. That is, the light transmission area 20d extends along the set of the two sides 10a₇ and 10a₉ (short sides), in which in which the facing-distance is long, among the two sets of sides, which face each other, of the display area 10a.

According to the embodiment, in the vicinity of the two sides 10a₇ and 10a₉ in which the facing-distance is long, high-density impurities are aggregated rather than the vicinity of the two sides 10a₆ and 10a₈ in which the facing-distance is short. However, the outer sides of the two sides 10a₇ and 10a₉ function as the light transmission area 20d, it is possible to move the impurities to the location which is separated from the display area 10a and aggregate the impurities in the location.

In addition, in the embodiment, the second shading layer 17, which overlaps light transmission area 20d in plan view, is also formed in the first substrate 10, similarly to Embodiment 1. The second shading layer 17 includes the same shading layer (the shading layer 7a and the relay electrode 7b) which is formed in the display area 10a of the first substrate 10, and includes light flexibility. Accordingly, the same effect as in Embodiment 1 is acquired, that is, it is possible to prevent light, which is transmitted through the light transmission area 20, from being transmitted through the first substrate 10 and then leaking.

Meanwhile, in the embodiment, the light transmission area 20d is configured with an area in which the first shading layer 27 is not formed. However, as in Embodiment 2, the light transmission area 20d may be configured with the openings 270 acquired by partially removing the first shading layer 27.

### Embodiment 4

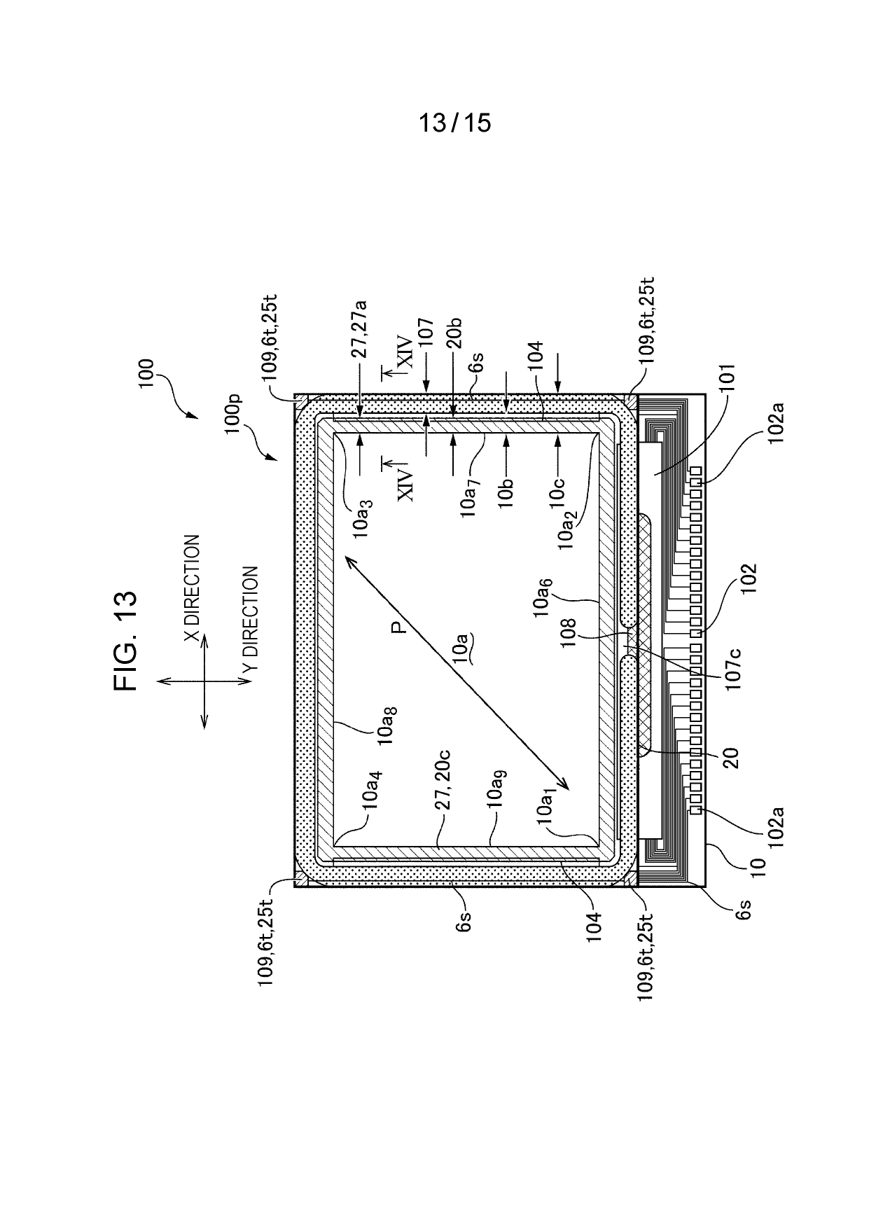

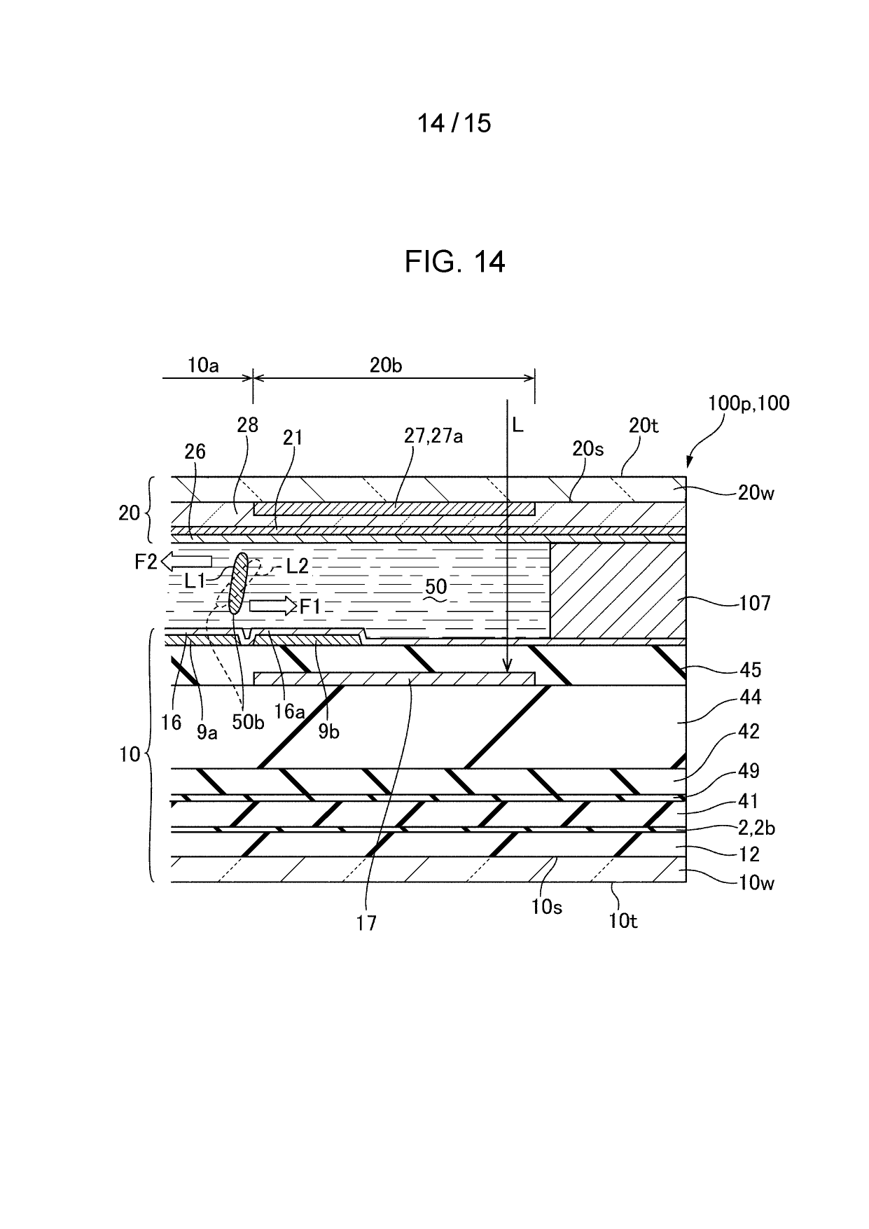

FIG. 13 is a plan view of a liquid crystal device according to Embodiment 4 of the invention. FIG. 14 is a sectional view of the liquid crystal device taken along a line XIV-XIV illustrated in FIG. 13. In Embodiments 1, 2, and 3, the light blocking area 20c and the light transmission area 20d are provided in the casing area 20b. However, in the embodiment, as illustrated in FIGS. 13 and 14, the first shading layer 27, which includes a partial transmission film 27a that causes light to be partially transmitted, is provided over an entire periphery of the casing area 20b. In the embodiment, the partial transmission film 27a includes a semi-transmission film, which is acquired by forming the light-shading film thinly, or a dielectric multi-layered film. Accordingly, the liquid crystal layer 50 is irradiated with light which is incident from the side of the second substrate 20. Accordingly, in a state in which an area which overlaps the first shading layer 27 in plan view is activated, the impurities move to the location separated from the display area 10a, and are aggregated in the location. Therefore, it is difficult that deterioration in the display qualities, such as burning (stain) of an image, is generated due to the aggregated impurities.

In addition, in the first substrate 10, the second shading layer 17, which overlaps light transmission area 20d in plan view, is formed. The second shading layer 17 includes the same layer as the shading layer (the shading layer 7a and the relay electrode 7b) which is formed in the display area 10a of the first substrate 10, and has light flexibility. Accordingly, the same effect as in Embodiment 1 is acquired, that is, it is possible to prevent light, which is transmitted through the light transmission area 20, from being transmitted through the first substrate 10 and then leaking.

### Other Embodiments

In the above-described embodiments, the invention is applied to the transmission-type liquid crystal device 100. However, the invention may be applied to the reflection-type liquid crystal device 100.

### Example of Installation in Electronic Apparatus

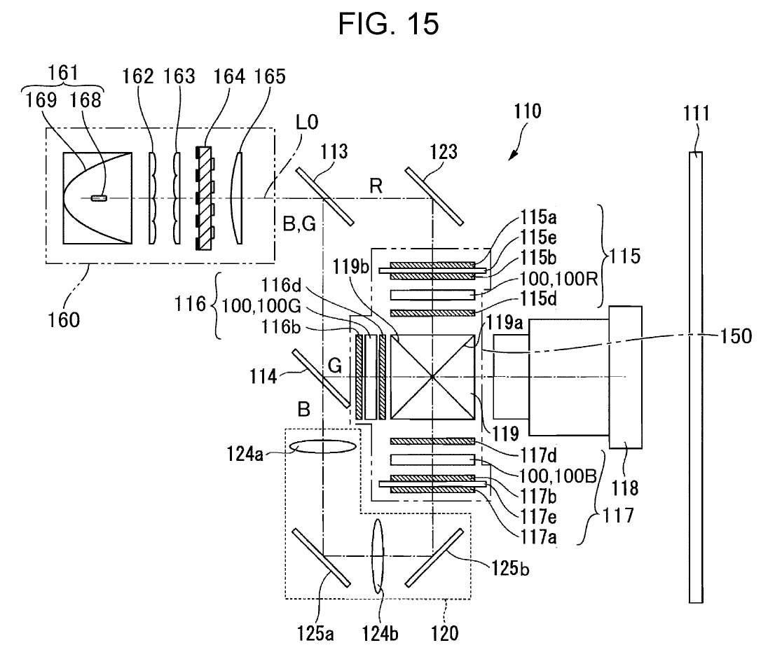

FIG. 15 is a schematic configuration diagram of a projection-type display apparatus (electronic apparatus) using the liquid crystal device 100 to which the invention is applied. Meanwhile, in the description below, a plurality of liquid crystal devices 100, to which light having different wavelength regions is supplied, are used. However, the liquid crystal device 100 to which the invention is applied is used for any type of the liquid crystal device 100.

The projection-type display apparatus 110 illustrated in FIG. 15 is a liquid crystal projector using the transmission-type liquid crystal device 100, and displays an image by irradiating a projection member 111 which includes a screen or the like with light. The projection-type display apparatus 110 includes, along an optical axis L0 of the apparatus, a lighting device 160, a plurality of liquid crystal devices 100 (liquid crystal light valves 115 to 117) to which light emitted from the lighting device 160 is supplied, a cross dichroic prism 119 (photosynthetic optical system) which synthesizes and emits light that is emitted from the plurality of liquid crystal devices 100, and a projection optical system 118 which projects light synthesized by the cross dichroic prism 119. In addition, the projection-type display apparatus 110 includes dichroic mirrors 113 and 114, and a relay system 120. In the projection-type display apparatus 110, the liquid crystal device 100 and the cross dichroic prism 119 form an optical unit 150. The liquid crystal device 100 is disposed such that light, which is emitted from the lighting device 160, is supplied from the side of the second substrate 20. Therefore, as described with reference to FIG. 8 or the like, light, which is incident into the light transmission area 20d from the side of the second substrate 20, is incident into the liquid crystal layer 50, and is cut by the second shading layer 17 which is provided in the first substrate 10. Therefore, in a state in which the impurities of the liquid crystal layer 50 are activated, the impurities move to the location separated from the display area 10a and are aggregated in the location. Therefore, it is possible to prevent such as burning (stain) of an image, from being generated due to the aggregated impurities, and it is possible to prevent light from leaking to a side of the projection optical system 118.

In the lighting device 160, along the optical axis L0 of the apparatus, a light source section 161, a first integrator lens 162, such as a fly-eye lens, which includes a lens array, a second integrator lens 163, such as a fly-eye lens, which includes a lens array, a polarized light conversion element 164, and a condenser lens 165 are sequentially arranged. The light source section 161 includes a light source 168 which emits white light including red light R, green light G and blue light B, and a reflector 169. The light source 168 is formed by an extra-high pressure mercury lamp or the like, and the reflector 169 includes a parabolic cross section. The first integrator lens 162 and the second integrator lens 163 equalize the luminance distribution of light emitted from the light source section 161. The polarized light conversion element 164 causes light emitted from the light source section 161 to be polarized light which has a specific vibration direction similar to, for example, s-polarized light.

A dichroic mirror 113 causes red light R, which is included in light emitted from the lighting device 160, to be transmitted therethrough, and reflects green light G and blue light B. A dichroic mirror 114 causes blue light B of green light G and blue light B, which are reflected in the dichroic mirror 113, to be transmitted therethrough, and reflects green light G. As above, the dichroic mirrors 113 and 114 form a color separation optical system which separates light emitted from the lighting device 160 into red light R, green light G, and blue light B.

A liquid crystal light valve 115 is a transmission-type liquid crystal device that modulates red light R, which is transmitted through the dichroic mirror 113 and is reflected in a reflection mirror 123, according to an image signal. The liquid crystal light valve 115 includes a λ/2 phase difference plate 115a, a first polarizing plate 115b, the liquid crystal device 100 (red liquid crystal device 100R), and a second polarizing plate 115d. Here, even when red light R, which is incident into the liquid crystal light valve 115, is transmitted through the dichroic mirror 113, polarized light is not changed, and thus s-polarized light is not changed.

The λ/2 phase difference plate 115a is an optical element that converts s-polarized light, which is incident into the liquid crystal light valve 115, into p-polarized light. The first polarizing plate 115b is a polarizing plate that cuts off s-polarized light and causes p-polarized light to be transmitted therethrough. The liquid crystal device 100 (red liquid crystal device 100R) is formed to convert p-polarized light into s-polarized light (in a case of halftone, circularly polarized light or elliptically polarized light) through modulation according to the image signal. The second polarizing plate 115d is a polarizing plate that cuts off p-polarized light and causes s-polarized light to be transmitted therethrough. Accordingly, the liquid crystal light valve 115 modulates red light R according to the image signal, and emits modulated red light R toward the cross dichroic prism 119. Meanwhile, the λ/2 phase difference plate 115a and the first polarizing plate 115b are disposed in a state in which the λ/2 phase difference plate 115a and the first polarizing plate 115b come into contact with a light-transmitting glass plate 115e which does not convert polarized light, and thus it is possible to prevent distortion of the λ/2 phase difference plate 115a and the first polarizing plate 115b due to the generation of heat.

A liquid crystal light valve 116 is a transmission-type liquid crystal device that modulates green light G, which is reflected in the dichroic mirror 114 after being reflected in the dichroic mirror 113, according to the image signal. The liquid crystal light valve 116 includes a first polarizing plate 116b, an liquid crystal device 100 (green liquid crystal device 100G), and a second polarizing plate 116d, similar to the liquid crystal light valve 115. Green light G, which is incident into the liquid crystal light valve 116, is s-polarized light which is reflected in and incident into the dichroic mirrors 113 and 114. The first polarizing plate 116b is a polarizing plate that cuts off p-polarized light and causes s-polarized light to be transmitted therethrough. The liquid crystal device 100 (green liquid crystal device 100G) is formed to convert s-polarized light into p-polarized light (in a case of halftone, circularly polarized light or elliptically polarized light) through modulation according to the image signal. The second polarizing plate 116d is a polarizing plate that cuts off s-polarized light and causes p-polarized light to be transmitted therethrough. Accordingly, the liquid crystal light valve 116 modulates green light G according to the image signal, and emits modulated green light G toward the cross dichroic prism 119.

A liquid crystal light valve 117 is a transmission-type liquid crystal device that modulates blue light B, which is reflected in the dichroic mirror 113 and passes through the relay system 120 after being transmitted through in the dichroic mirror 114, according to the image signal. The liquid crystal light valve 117 includes a λ/2 phase difference plate 117a, a first polarizing plate 117b, a liquid crystal device 100 (blue liquid crystal device 100B), and a second polarizing plate 117d, similar to the liquid crystal light valves 115 and 116. Blue light B, which is incident into the liquid crystal light valve 117, is reflected in the dichroic mirror 113 and is reflected in the two reflection mirrors 125a and 125b of the relay system 120 after being transmitted through the dichroic mirror 114, and thus blue light B is s-polarized light.

The λ/2 phase difference plate 117a is an optical element that converts s-polarized light, which is incident into the liquid crystal light valve 117, into p-polarized light. The first polarizing plate 117b is a polarizing plate that cuts off s-polarized light and causes p-polarized light to be transmitted therethrough. The liquid crystal device 100 (blue liquid crystal device 100B) is formed to convert p-polarized light into s-polarized light (in a case of halftone, circularly polarized light or elliptically polarized light) through modulation according to the image signal. The second polarizing plate 117d is a polarizing plate that cuts off p-polarized light and causes s-polarized light to be transmitted therethrough. Accordingly, the liquid crystal light valve 117 modulates blue light B according to the image signal, and emits modulated blue light B toward the cross dichroic prism 119. Meanwhile, the λ/2 phase difference plate 117a and the first polarizing plate 117b are disposed in a state in which the λ/2 phase difference plate 117a and the first polarizing plate 117b come into contact with a glass plate 117e.

The relay system 120 includes relay lenses 124a and 124b and reflection mirrors 125a and 125b. The relay lenses 124a and 124b are provided to prevent optical loss due to long optical path of blue light B. The relay lens 124a is arranged between the dichroic mirror 114 and the reflection mirror 125a. The relay lens 124b is arranged between the reflection mirrors 125a and 125b. The reflection mirror 125a reflects blue light B, which is transmitted through the dichroic mirror 114 and is emitted from the relay lens 124a, toward the relay lens 124b. The reflection mirror 125b reflects blue light B, which is emitted from the relay lens 124b, toward the liquid crystal light valve 117.

The cross dichroic prism 119 is a color synthesis optical system in which two dichroic films 119a and 119b are perpendicularly arranged in an X-shape. The dichroic film 119a is a film which reflects blue light B and causes green light G to be transmitted therethrough, and the dichroic film 119b is a film which reflects red light R and causes green light G to be transmitted therethrough. Accordingly, the cross dichroic prism 119 synthesizes red light R, green light G, and blue light B which are modulated in respective liquid crystal light valves 115 to 117, and emits synthesized light toward the projection optical system 118.

Meanwhile, light which is emitted to the cross dichroic prism 119 from the liquid crystal light valves 115 and 117 is s-polarized light, and light which is emitted to the cross dichroic prism 119 from the liquid crystal light valve 116 is p-polarized light. As above, when light which is emitted to the cross dichroic prism 119 is converted into different types of polarized light, it is possible to synthesize light which is emitted from each of the liquid crystal light valves 115 to 117 in the cross dichroic prism 119. Here, generally, the dichroic films 119a and 119b are excellent in reflectance properties of s-polarized light. Therefore, it is assumed that red light R and blue light B which are reflected in the dichroic films 119a and 119b are s-polarized light and green light G which is transmitted through the dichroic films 119a and 119b is p-polarized light. The projection optical system 118 includes projection lenses (not shown in the drawing), and projects light which is synthesized in the cross dichroic prism 119 on to a projection member 111 such as the screen.

### Other Projection-Type Display Apparatus

In the projection-type display apparatus, configuration may be made such that an LED light source, which emits light of the respective colors, or the like is used as the light source section and light of the respective colors emitted from the LED light source is supplied to another liquid crystal device.

The liquid crystal device 100 to which the invention is applied may be used as a projection-type Head-Up Display (HUD) or a direct viewing type Head Mount Device (HMD), a mobile phone, a Personal Digital Assistants (PDA), a digital camera, a liquid crystal television, a car navigation apparatus, a video phone, or the like in addition to the above-described electronic apparatus.

The entire disclosure of Japanese Patent Application No. 2016-178286, filed Sep. 13, 2016 is expressly incorporated by reference herein.

What is claimed is:

1. A liquid crystal device comprising:
a first substrate that includes a plurality of pixel electrodes and a first oriented film;
a second substrate that includes a common electrode and a second oriented film;
a seal material that bonds the first substrate to the second substrate; and
a liquid crystal layer that is maintained in an area surrounded by the seal material between the first substrate and the second substrate,
wherein, in a frame-shaped casing area interposed between the seal material and a quadrangular display area, the second substrate is provided with a light blocking area, in which a first shading layer is provided along sides of the display area, and a light transmission area which has higher light transmittance than the light blocking area, and
wherein the first substrate is provided with a second shading layer which overlaps the light transmission area in plan view.

2. The liquid crystal device according to claim 1,
wherein the light transmission area corresponds to openings of the first shading layer.

3. The liquid crystal device according to claim 1,
wherein the light transmission area is a partial transmission film which causes light to be partially transmitted.

4. The liquid crystal device according to claim 1,
wherein the first oriented film or the second oriented film causes liquid crystal molecules of the liquid crystal layer to be oriented from one side of a set, in which a facing-distance is long, toward one side of a set, in which the facing-distance is short, among two sets of sides, which face each other, of the display area, and to be oriented from another side of the set, in which the facing-distance is short, toward another side of the set in which the facing-distance is long.

5. The liquid crystal device according to claim 4,
wherein a direction, in which the liquid crystal molecules of the liquid crystal layer are oriented, has an angle of 45° or 135° with respect to one side of the set in which the facing-distance is long.

6. The liquid crystal device according to claim 1,
wherein the light transmission area is provided on an outer side of four corners of the display area.

7. The liquid crystal device according to claim 1,
wherein the light transmission area is provided over an entire periphery of the display area.

8. The liquid crystal device according to claim 1,
wherein the light transmission area extends along two sides of a set, in which a facing-distance is long, among two sets of sides, which face each other, of the display area.

9. The liquid crystal device according to claim 1,
wherein the first substrate includes a dummy pixel electrode in the light blocking area along a side of the display area, and
wherein the light transmission area is formed to correspond to the dummy pixel electrode.

10. A liquid crystal device comprising:
a first substrate that includes a plurality of pixel electrodes and a first oriented film;
a second substrate that includes a common electrode and a second oriented film;
a seal material that bonds the first substrate to the second substrate; and
a liquid crystal layer that is maintained in an area surrounded by the seal material between the first substrate and the second substrate,
wherein the second substrate is provided with a first shading layer, which includes a partial transmission film that causes light to be partially transmitted, over an entire periphery of the frame-shaped casing area which is interposed between the seal material and the quadrangular display area, and
wherein the first substrate is provided with a second shading layer which overlaps the first shading layer in plan view.

11. The liquid crystal device according to claim 1,
wherein the second shading layer includes the same layer as wirings or the electrodes which are provided in the display area of the first substrate.

12. The liquid crystal device according to claim 11,
wherein the second shading layer includes a reflective metal layer.

13. The liquid crystal device according to claim 1,
wherein the first oriented film and the second oriented film have a columnar structure, and
wherein the liquid crystal molecules of the liquid crystal layer have negative dielectric anisotropy.

14. An electronic apparatus comprising the liquid crystal device according to claim 1.

15. An electronic apparatus comprising the liquid crystal device according to claim 2.

16. An electronic apparatus comprising the liquid crystal device according to claim 3.

17. An electronic apparatus comprising the liquid crystal device according to claim 4.

18. An electronic apparatus comprising the liquid crystal device according to claim 5.

19. An electronic apparatus comprising the liquid crystal device according to claim 6.

20. The electronic apparatus according to claim 14, further comprising:
a light source section that emits light to be supplied to the liquid crystal device; and
a projection optical system that projects light which is modulated by the liquid crystal device,
wherein, in the liquid crystal device, light which is emitted from the light source section is supplied from a side of the second substrate.
